(19) United States
(12) Patent Application Publication
(10) Pub. No.: US 2008/0088482 A1
(43) Pub. Date: Apr. 17, 2008

(54) Vehicle information recording apparatus

(75) Inventors: Katsutoshi Okada, Kobe-shi (JP); Mariko Yago, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-shi (JP)

(21) Appl. No.: 11/907,605

(22) Filed: Oct. 15, 2007

(30) Foreign Application Priority Data
Oct. 15, 2006 (JP) 2006-280817
Oct. 5, 2007 (JP) 2007-262647

(51) Int. Cl. G08G 1/017

(52) U.S. Cl. 340/937

(57) ABSTRACT

A vehicle information recording apparatus which is capable of recording information to be recorded on a recording medium without fail even in a case where electric power is supplied in a limited quantity is provided. Under the circumstances where a signal indicative of a command to record the information of images taken by a camera is issued and a main power source's power detection portion detects the absence of electric power supply from a vehicle power source, a CPU performs a second recording operation which differs from a first recording operation in a manner that a predetermined part of the image information stored in a second SD-RAM on a frame-by-frame basis can be recorded on a CF card by exploiting the electric power supply from a backup power source section.

### BACKGROUND OF THE INVENTION

1. Field of the Invention

The present invention relates to a vehicle information recording apparatus for storing therein vehicle information concerning a vehicle, for example, information on images taken by a camera mounted in the vehicle, and recording the vehicle information on a recording medium according to the condition of the vehicle, for example.

2. Description of the Related Art

As a vehicle information recording apparatus of related art, there is known an apparatus for storing information on images taken by a camera mounted in a vehicle, in a cyclic manner, in which, in the event of the vehicle being involved in an accident, the accident triggers recording of the information on a plurality of images stored therein on a recording medium. In such an apparatus, the information on a plurality of images is stored in an endless manner, wherefore even the information of an image acquired immediately before the accident can be recorded on the recording medium (for example, refer to Japanese Unexamined Patent Publication JP-A 2000-006854).

In the vehicle information recording apparatus of related art, electric power is supplied from a power source designed for vehicle use. In the event that the vehicle is involved in an accident, the supply of power from the made-for-vehicle power source to the vehicle information recording apparatus may be caused to cease due to the impact of the accident. In this case, the information stored in an interior memory, for example, the information on images taken by a camera that has been temporarily stored, cannot be recorded on the recording medium properly.

In some cases, for example, the vehicle information recording apparatus is provided with a backup power source for effecting the supply of power kept in stock in a case where power is no longer supplied from the made-for-vehicle power source. In this case, however, since there is a limit to the quantity of power which is supplied from the backup power source, it follows that the information stored in the interior memory is recorded on the recording medium with use of the power from the backup power source only within a limited period of time. In consequence, even though an encounter with an accident which is so serious that the made-for-vehicle power source is incapable of effecting power supply, of particular necessity, requires successful recording of the information stored in the interior memory on the recording medium, information to be recorded, for example, the information of an image which has been taken by a camera immediately before the accident may not be recorded on the recording medium properly.

### SUMMARY OF THE INVENTION

An object of the invention is to provide a vehicle information recording apparatus which is capable of recording information to be recorded on a recording medium without fail even in a case where electric power is supplied in a limited quantity.

According to the invention, a first memory records information concerning a vehicle in a cyclic manner. A recording control section effects recording of the information concerning a vehicle recorded on the first memory, on a second memory in accordance with a predetermined condition. The recording control section is supplied with electric power from a main power source section. An auxiliary power source section acts as a backup for the supply of electric power from the main power source section to the recording control section. The recording control section allows, in the presence of electric power supply from the auxiliary power source section, part of the information recorded on the first memory to be recorded on the second memory.

According to the invention, in a case where the recording control section, which is normally supplied with electric power from the main power source section, is supplied with electric power from the auxiliary power source section, part of the information recorded on the first memory is recorded on the second memory. In this construction, for example, even if the vehicle is involved in an accident and consequently the supply of electric power from the main power source section is interrupted due to the impact of the accident, the recording control section is able to record part of the information recorded on the first memory on the second memory without fail by exploiting the electric power supply from the auxiliary power source section.

### BRIEF DESCRIPTION OF THE DRAWINGS

Other and further objects, features, and advantages of the invention will be more explicit from the following detailed description taken with reference to the drawings wherein:

FIG. 1 is a block diagram showing the electrical configuration of a drive recorder in accordance with one embodiment of the invention;

FIG. 2 is a view of assistance in explaining the installation position of a camera in a vehicle;

FIG. 3 is a view showing how still image information is recorded on the CF card at fixed time intervals δ on the basis of G sensor output values;

FIG. 4 is a view showing the relationship between part of image information and information about position and so forth;

FIG. 5 is a view showing the relationship between a G sensor output value in excess of a threshold and a recording range Rh, which is the range of recording image information on the CF card;

FIG. 6 is a view of assistance in explaining a method for determining a threshold for the G sensor output value;

FIG. 7 is a block diagram showing a part of the configuration of the drive recorder in accordance with one embodiment of the invention;

FIG. 8 is a view of assistance in explaining execution of a second recording operation for a case where the image information stored in the second SD-RAM is recorded on the CF card after the thinning-out of the information;

FIG. 9 is a flow chart showing the procedural steps to be followed by the CPU in performing the second recording operation to record the image information stored in the second SD-RAM on the CF card after completing the thinning-out process;

FIG. 10 is a view of assistance in explaining the execution of the second recording operation for a case where the image information stored in the second SD-RAM is recorded on the CF card successively in reverse chronological order;

FIG. 11 is a block diagram showing a part of the configuration of the drive recorder of another embodiment of the invention;

FIG. 12 is a flow chart showing the procedural steps to be followed by the CPU in regard to the operation to complete the recording of image information on the CF card;

FIG. 13 is a flow chart showing the procedural steps to be followed by the CPU in regard to the operation to disable the recording of image information on the CF card; and

FIG. 14 is a block diagram showing a part of the configuration of the drive recorder of still another embodiment of the invention.

### DETAILED DESCRIPTION OF THE PREFERRED EMBODIMENTS

Now referring to the drawings, preferred embodiments of the invention are described below.

Hereinafter, a plurality of forms for implementing the invention will be described by way of embodiments. In the following explanations, such components as correspond to those that have already been described in accordance with the embodiment preceding will be identified with the same reference symbols, and overlapping descriptions may be omitted. In a case where only a part of the structure of an embodiment is described, the other part thereof will be deemed to be the same as that of the preceding embodiment. Not only it is possible to utilize some components specifically described in accordance with the different embodiments in combination, but it is also possible to combine the different embodiments per se in part so long as no problem will be posed as to the combination. A vehicle information recording apparatus (hereinafter also referred to as a “drive recorder”) which will hereinafter be described in accordance with the following embodiments can suitably be mounted in, for example, a passenger automobile with a battery voltage of twelve volts.

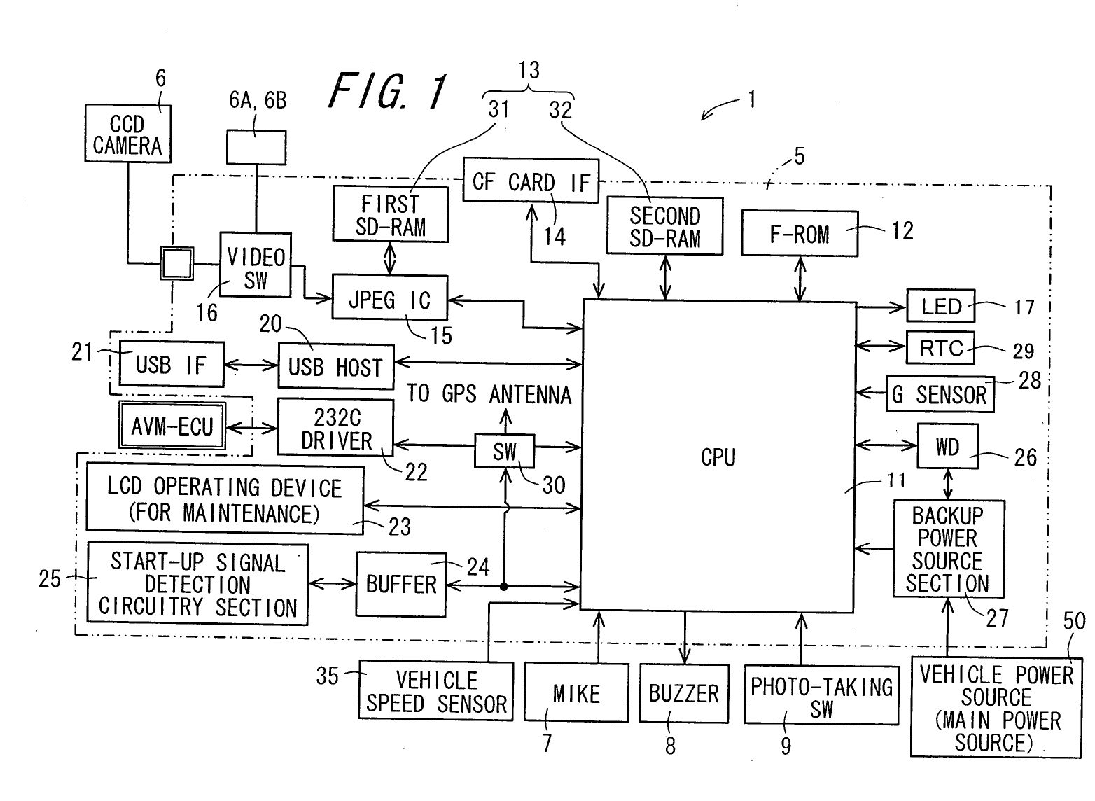

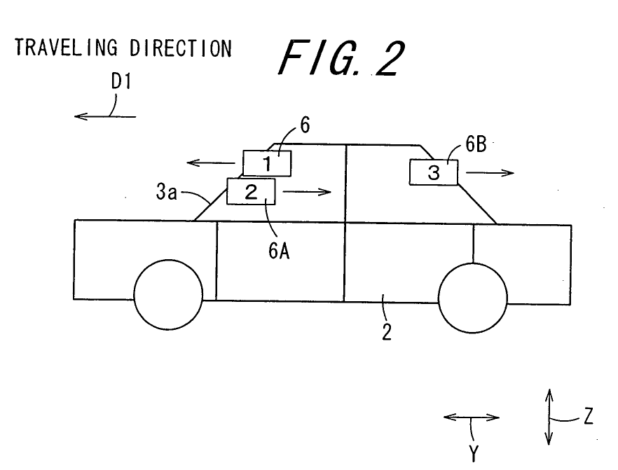

FIG. 1 is a block diagram showing the electrical configuration of a drive recorder 1 in accordance with one embodiment of the invention. FIG. 2 is a view of assistance in explaining the installation position of a camera in a vehicle 2. The drive recorder 1 is designed to store therein image information which is provided from a camera installed in the vehicle 2 as an image taking apparatus, as well as to record, where a predetermined condition is fulfilled, image information, audio information, and so forth on a recording medium, to be specific, a Compact Flash (trademark) card (hereinafter also referred to as a “CF card”) 3, which is a nonvolatile memory. The CF card 3 is constructed by electrically connecting a flash memory, which is capable of remembering information even in the absence of electric power, to a controller circuit which is responsible for input/output operations between the card and an external system.

The drive recorder 1 is composed of a drive recorder main body 5, a camera 6 disposed as an image taking apparatus, a microphone (hereinafter referred to as a “mike”) 7 for acquiring audio information in the interior of the vehicle, and a buzzer 8 for issuing warning information. The camera 6 and the mike 7 are provided independently of the drive recorder main body 5, yet are electrically connected thereto. The buzzer 8 is provided integrally with the drive recorder main body 5. The vehicle of interest 2 is provided with at least one camera 6.

The camera 6 is realized by using a CCD (Charge Coupled Device) camera. In order to take a picture of a scene ahead of the vehicle 2 as indicated by an arrow D1 depicted in FIG. 2, for example, the camera 6 is attached to a windshield 2a at the back of a rearview mirror through the use of a non-illustrated bracket. That is, the camera 6 is fixed so as to be oriented in a direction forwardly of the vehicle. In the drive recorder 1, optionally, a second camera 6, or second and third cameras 6 may be disposed in the vehicle of interest 2. More specifically, it is possible to dispose a photo-taking camera 6A in the interior of the vehicle, or dispose in addition a photo-taking camera 6B in a rearward position of the vehicle. There may be cases where a photo-taking switch 9 for effecting image pickup by those cameras 6 is provided independently of the drive recorder main body 5 yet is electrically connected thereto.

The drive recorder main body 5 has formed therein an insertion opening for allowing the insertion and withdrawal of the CF card 3. A recording medium which can be inserted into and extracted from the insertion opening is not limited to the CF card 3 described above, but may be a SD (Secure Digital) memory card, a memory stick, or a smart media, for instance.

The drive recorder main body 5 includes a CPU (Central Processing Unit) 11, a Flash ROM (Flash Read Only Memory; F-ROM for short) 12, a RAM (Random Access Memory) 13 acting as a storage section, a CF card interface (CF card IF for short) 14, a JPEG IC (JPEG: Joint Photographic coding Experts Group, IC: Integrated Circuit) 15, a video switch (video SW for short) 16, and a Light Emitting Diode (LED for short) 17.

The drive recorder main body 5 further includes a USB HOST 20 which is an element having a USB (Universal Serial Bus) host capability, a USB interface (USB IF for short) 21, a communication driver 22, a LCD (Liquid Crystal Display) operating device connector 23, a buffer 24, a start-up signal detection circuitry section 25 for detecting vehicular signals including a power-up signal in Hi/Lo signal mode provided from the vehicle 2, a watch dog IC (WD for short) 26 having a watch dog function, a backup power source section 27, a G sensor 28, a real time clock (RTC for short) 29, and a non-illustrated counter for counting vehicle speed pulses. The LCD operating device connector 23 is designed to receive connection of a LCD operating device which allows input of driver information.

The G sensor 28 is capable of detecting the acceleration of gravity exerted in an anteroposterior direction of the vehicle 2 as well as in a lateral direction of the vehicle 2, namely a so-called G sensor output value. The anteroposterior direction includes front and rear directions in which the vehicle 2 travels. The lateral direction refers to directions of from right to left and from left to right when viewed toward the front direction. A direction which is perpendicular to the anteroposterior direction and the lateral direction is regarded as a vertical direction. The anteroposterior direction is defined as a Y axis direction, and the lateral direction is defined as an X axis direction. A G sensor output value corresponding to the X axis direction and a G sensor output value corresponding to the Y axis direction are detected and recorded on an individual basis.

In the F-ROM 12 is stored a control program for exercising control over the hardware resources constituting the drive recorder main body 5. The RAM 13 is composed of a first SD-RAM (Synchronous Dynamic Random Access Memory) 31 and a second SD-RAM 32. In the first SD-RAM 31 is temporarily stored image information which has been converted into JPEG-style information by the JPEG IC 15. In the second SD-RAM 32 is temporarily stored vehicle information concerning the vehicle 2 such as a G sensor output value detected by the G sensor 28, information on the driving speed of the vehicle 2 (hereinafter referred to as the “vehicle speed”) detected by a subsequently-described vehicle speed sensor 35, and a vehicular signal detected by the start-up signal detection circuitry section 25, the aforementioned image information converted into JPEG-style information, audio information inputted through the mike 7, and so forth in a cyclic manner. The RTC 29 provides system clock and clock information including current time to the CPU 11. The CPU 11, the F-ROM 12, and the second SD-RAM 32 are operated on the basis of the system clock.

The F-ROM 12, the second SD-RAM 32, the CF card IF 14, the LED 17, and the RTC 29 are each electrically connected to the CPU 11. Moreover, the first SD-RAM 31 and the video SW 16 are each electrically connected to the CPU 11 via the JPEG IC 15. The video SW 16 is provided as a selector switch in the case of disposing a plurality of cameras 6 to allow selection among the cameras 6 for taking images over a predetermined time interval.

The USB IF 21 is electrically connected to the CPU 11 via the USB HOST 20. Moreover, the communication driver (232C driver) 22, the LCD operating device connector 23, the buffer 24, the WD 26, the G sensor 28, and the backup power source section 27 are each electrically connected to the CPU 11. The buffer 24 is electrically connected to the start-up signal detection circuitry section 25. The backup power source section 27 is electrically connected to the WD 26. In a case where the power-up signal is unavailable, a switch 30 is operated to effect changing from an input-via-communication driver 22 mode to an input-via-GPS antenna mode. In this case, the position of the vehicle 2 can be detected by means of the GPS alone. The backup power source section 27 supplies electric power to the CPU 11 in a case where the supply of electric power from a vehicle power source 50 mounted in the vehicle is caused to cease.

In this embodiment, the second SD-RAM 32 corresponds to a first memory, and the CF card 3 corresponds to a second memory. Moreover, the JPEG IC 15 corresponds to an inputting section. The CF card IF 14 corresponds to a memory connecting section. The CPU 11 corresponds to a recording control section as well as a control section. The backup power source section 27 corresponds to an auxiliary power source section. The G sensor 28 corresponds to an impact detecting section.

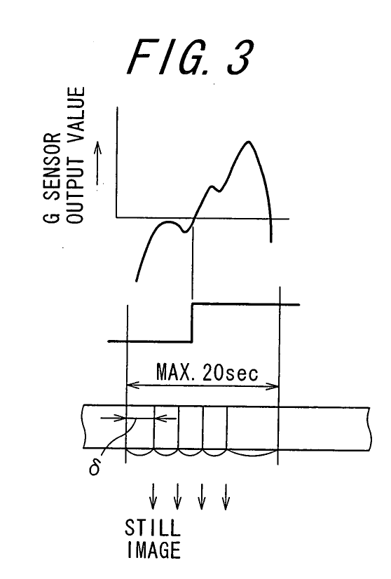

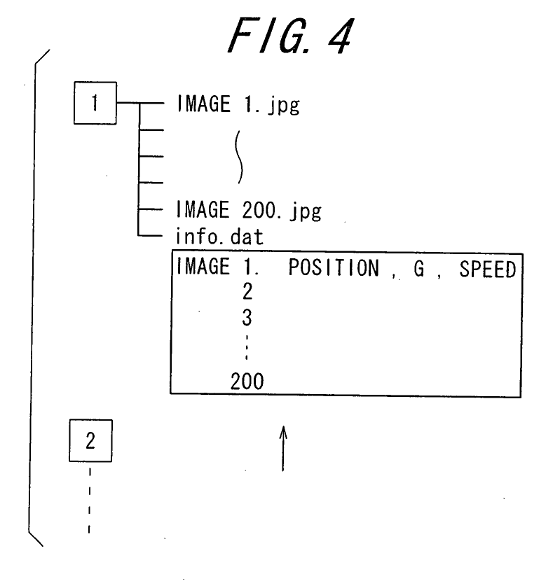

FIG. 3 is a view showing how still image information is recorded on the CF card 3 at fixed time intervals δ on the basis of G sensor output values. FIG. 4 is a view showing the relationship between part of image information and information about position and so forth. Under the control of the CPU 11, input images that have been taken by the camera 6 and inputted to the drive recorder main body 5 are converted into JPEG-style image information by the JPEG IC 15. The JPEG style-converted image information is then temporarily stored in the first SD-RAM 31. After that, under the control of the CPU 11, the JPEG style-converted image information is successively stored in the second SD-RAM 32 on a frame-by-frame basis in chronological order. At this time, for example, a single piece (1 frame) of still image is stored in the second SD-RAM 32 in “image *.jpg” format (see FIG. 4). The symbol “*” takes on a value of integer.

Under the control of the CPU 11, as additional information as to the still images, G sensor output values, positional information, time information, vehicle speed information provided from the vehicle speed sensor 35 (see FIG. 1), and audio information provided through the mike 7 as to the vehicle of interest 2 is stored in the second SD-RAM 32 one after another.

In a case where a predetermined recoding condition is fulfilled, the CPU 11 effects control of the buzzer 8 in a manner so as to issue a sign indicative of the starting of recording. Thereupon, under the control of the CPU 11, the JPEG style-converted image information, the G sensor output values, the positional information, the time information, and the vehicle speed information each stored in the second SD-RAM 32 is recorded on the CF card 3. The present embodiment is so designed that, for example, 10 pieces (10 frames) of still images are recorded on the CF card 3 in the period of one second; that is, 200 pieces (200 frames) of still images can be recorded on the CF card 3 in the period of twenty seconds at the maximum per 1 event. Note that “1 event” is equivalent to one circumstance where the predetermined recoding condition is fulfilled.

More particularly, for example, as shown in FIG. 4, on the CF card 3 is recorded an image information group composed of 200 pieces of still images “image 1.jpg”, . . . “image 200.jpg” in the period of twenty seconds at the maximum. Moreover, the file name of each of the still images “image 1” . . . “image 200” included in the image information group is correlated with the positional information, the time information, the G sensor output values, and the vehicle speed information as to the vehicle 2 thereby to obtain additional information for the image information group. This additional information is also recorded on the CF card 3.

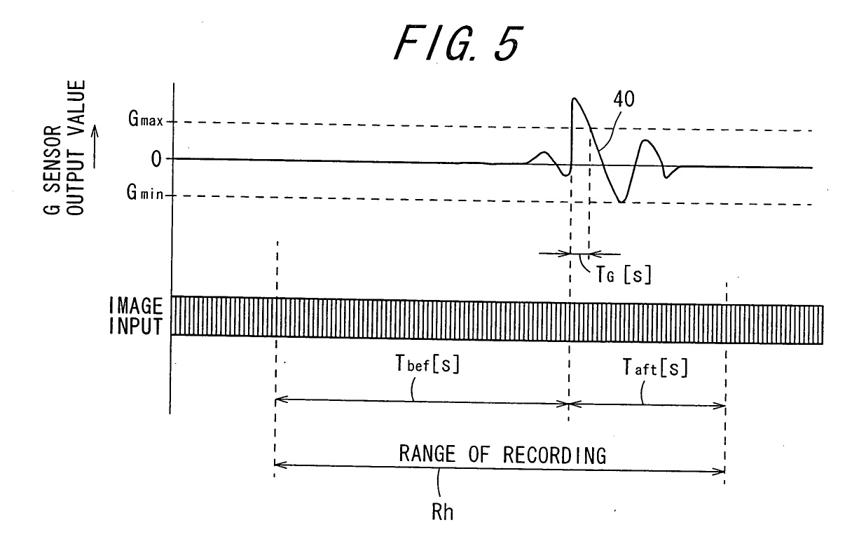

FIG. 5 is a view showing the relationship between a G sensor output value 40 in excess of a threshold and a recording range Rh, which is the range of recording image information on the CF card 3. As a recording condition, upon the G sensor output value 40 exceeding the threshold Gmax or Gmin, over the recording range of the period of twenty seconds at the maximum with reference to a time point when the threshold has been exceeded, the JPEG style-converted images, their respective G sensor output values, positional information, time information, and vehicle speed information, and audio information provided through the mike 7 recorded on the second SD-RAM 32 in an endless manner are recorded on the CF card 3. The time point when the threshold has been exceeded will hereinafter be also referred to as “the time point of occurrence of trigger”. A value obtained by adding up a recording duration of T_{bef} seconds as observed before the occurrence of trigger and a recording duration of T_{aft} seconds as observed after the occurrence of trigger is equivalent to the total sum of the recording time (recording range) in one event.

In the present embodiment, the before-trigger recording duration T_{bef} is set to twelve seconds, whereas the after-trigger recording duration T_{aft} is set to eight seconds. The before-trigger recording duration T_{bef} can be adjusted within a range of from eight seconds to twelve seconds, and the after-trigger recording duration T_{aft} can be adjusted within a range of from eight seconds to twelve seconds, too. In other words, the recording range Rh in 1 event can be set at twenty seconds at the maximum so long as the before-trigger recording duration falls within a range of from eight seconds to twelve seconds and the after-trigger recording duration falls within a range of from eight seconds to twelve seconds.

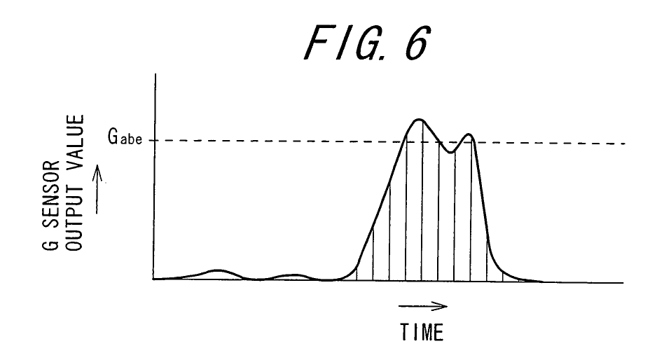

FIG. 6 is a view of assistance in explaining a method for determining a threshold for the G sensor output value. The CPU 11 acquires an output produced from the G sensor 28 and then determines whether the output exceeded a threshold G_{abe} or not. As has already been described, the G sensor 28 is a sensor of biaxial type that allows detection of gravitational acceleration both in the X axis direction and in the Y axis direction. That is, the G sensor 28 is designed to be able to detect gravitational acceleration both in the anteroposterior direction and lateral direction of the vehicle 2. Accordingly, not only a collision accident in the anteroposterior direction but also a collision accident in the lateral direction can be detected without fail, and thus the cause of the accident can be analyzed properly. The determination of the threshold is made on the basis of a vector sum of the gravitational acceleration in the anteroposterior direction and that in the lateral direction. The threshold thus obtained can be changed to any given value through a setting operation.

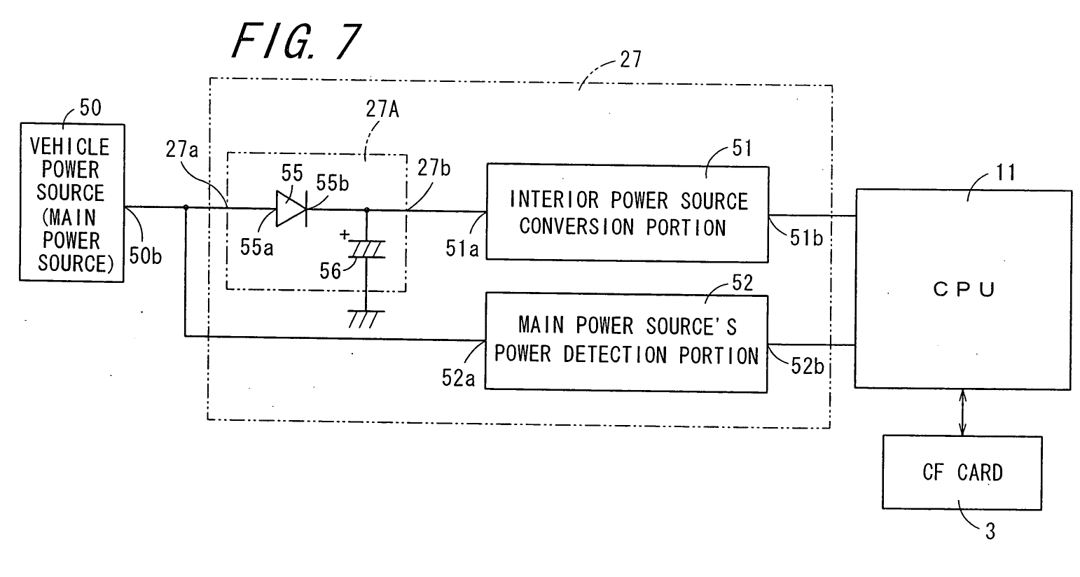

FIG. 7 is a block diagram showing a part of the configuration of the drive recorder 1 in accordance with one embodiment of the invention. The backup power source section 27 of the drive recorder 1 of this embodiment is composed of a backup circuitry portion 27A, an interior power source conversion portion 51, and a main power source's power detection portion 52 acting as a power detecting section.

The vehicle power source (hereinafter also referred to as a “main power source”) 50 mounted in the vehicle 2 has its output portion 50b electrically connected to an input portion 27a of the backup circuitry portion 27A and also to an input portion 52a of the main power source's power detection portion 52. The backup circuitry portion 27A has its output portion 27b electrically connected to an input portion 51a of the interior power source conversion portion 51. An output portion 51b of the interior power source conversion portion 51 and an output portion 52b of the main power source's power detection portion 52 are each electrically connected to the CPU 11.

In the present embodiment, the backup circuitry portion 27A is composed of a diode 55 and a capacitor 56. More specifically, the output portion 50b of the vehicle power source 50 is electrically connected to an anode 55a of the diode 55. Between a cathode 55b of the diode 55 and the interior power source conversion portion 51 is connected the capacitor 56, the other end of which is connected to ground. The point of connection between the cathode 55b of the diode 55 and a positive terminal of the capacitor 56 is electrically connected to the input portion 51a of the interior power source conversion portion 51. The capacitor 56 may be realized by using an electrolytic capacitor or an electrolytic double layer capacitor.

In the backup circuitry portion 27A, in the presence of electric power supply from the vehicle power source 50, the capacitor 56 is charged with use of the supplied power. On the other hand, in the absence of electric power supply from the vehicle power source 50, the electric charge kept in stock in the capacitor is discharged whereby to supply electric power to the interior power source conversion portion 51.

In the interior power source conversion portion 51, a voltage provided from the backup circuitry portion 27A is converted into a voltage for use in the CPU 11. The voltage thus converted is fed to the CPU 11. For example, the interior power source conversion portion 51 is realized by using a regulator.

The main power source's power detection portion 52 detects whether electric power is being supplied from the vehicle power source 50 or not. The result of the detection is fed to the CPU 11. More specifically, the presence or absence of electric power supply from the vehicle power source 50 is detected on the basis of a judgment as to whether the voltage value or current value provided from the vehicle power source 50 is 0 or not. More particularly, in a case where the voltage value or current value provided from the vehicle power source 50 is found to be 0, the main power source's power detection portion 52 detects the absence of electric power supply from the vehicle power source 50.

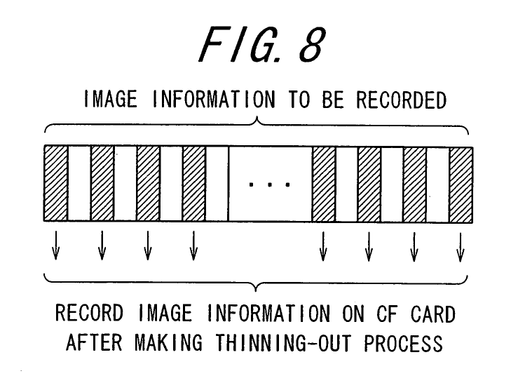

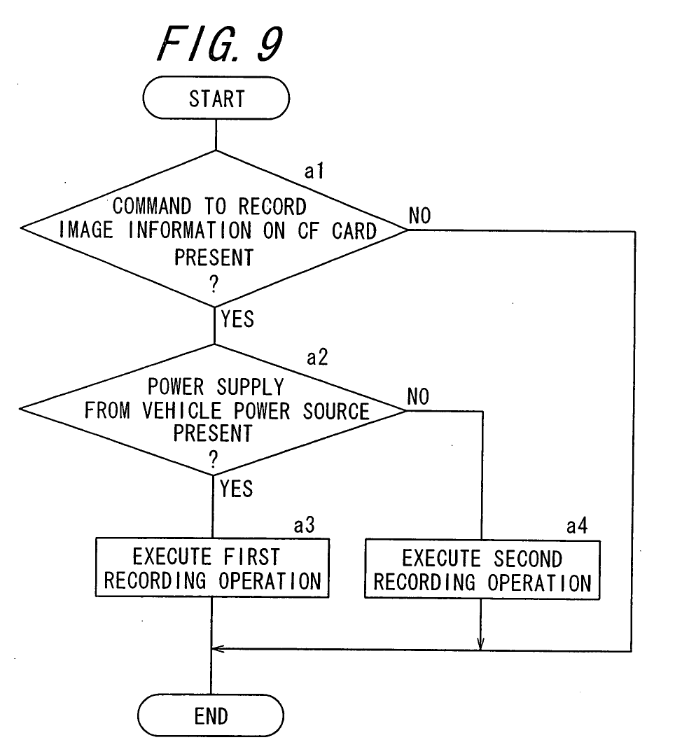

FIG. 8 is a view of assistance in explaining execution of a second recording operation for a case where the image information stored in the second SD-RAM 32 is recorded on the CF card 3 after the thinning-out of the information. FIG. 9 is a flow chart showing the procedural steps to be followed by the CPU 11 in performing the second recording operation to record the image information stored in the second SD-RAM 32 on the CF card 3 after completing the thinning-out process.

Under circumstances where a command to record the information of images taken by the camera 6 stored in the second SD-RAM 32 on the CF card 3, to be specific, a signal indicative of the command is issued, and the main power source's power detection portion 52 detects the presence of electric power supply from the vehicle power source 50 (hereinafter also referred to as “normal circumstances”), the CPU 11 performs a first recording operation in a manner that the image information stored in the second SD-RAM 32 within a predetermined period of time including the time at which the signal was issued can be successively recorded on the CF card 3 in the order in which the frames were stored in the second SD-RAM 32.

On the other hand, under circumstances where a signal indicative of a command to record the information of images taken by the camera 6 stored in the second SD-RAM 32 on the CF card 3 is issued and the main power source's power detection portion 52 detects the absence of electric power supply from the vehicle power source 50 (hereinafter also referred to as “no-power circumstances”), the CPU 11 performs the second recording operation, which is different from the first recording operation, in a manner that at least part of the image information stored in the second SD-RAM 32, to be specific, that part of the image information stored in the second SD-RAM 32 which remains after thinning out part of the frames from the image information, can be recorded on the CF card 3 successively in the order in which the frames were stored in the second SD-RAM 32, by exploiting the electric power supply from the backup power source section 27.

Of the image information stored in the second SD-RAM 32, the image information to be recorded on the CF card 3 in the second recording operation is, the same as in the case of the first recording operation, within twenty seconds from twelve seconds before the time point of occurrence of trigger to eight seconds after the time point of occurrence of trigger. Note that the recording range of image information by the second recording operation may be set to a range of time from twelve seconds before the time point of occurrence of trigger to a time point of start of no-power circumstances, or using the no-power circumstances as a reference, the recording range may be from from a predetermined time (time shorter than twelve seconds for which the information was to be recorded, e.g. ten seconds) before the time point of start of no-power circumstances, to the time point of start of no-power circumstances. By recording the image information in the range shorter than the time for which the information was to be recorded (twelve seconds) and with a thinning-out operation, the size of the backup power source section can be reduced.

The present embodiment is so designed that, under the normal circumstances, 10 frames of still images can be recorded on the CF card 3 in the period of one second, and that, under the no-power circumstances, the thinning-out of the frames is made every a predetermined number of the frames whereby to record 5 frames of still images on the CF card 3 in the period of one second.

In the flow chart shown in FIG. 9, the operation starts a sequence of steps at the condition of turning the drive recorder main body 5 on. This operation is executed by the CPU 11. Upon start-up of the operation, the procedure proceeds to Step a1. In Step a1, it is determined whether a command to record the image information stored in the second SD-RAM 32 on the CF card 3 was issued or not. In the presence of the recording command, the procedure proceeds to Step a2. In the absence of the recording command, the sequence of operating steps come to an end.

For example, upon the G sensor output value exceeding the threshold Gmax or Gmin, a command to record the image information stored in the second SD-RAM 32 on the CF card 3 is issued to the CPU 11. Therefore, the presence or absence of the command to record the image information stored in the second SD-RAM 32 on the CF card 3 is determined by the CPU 11 on the basis of a judgment as to whether the G sensor output value exceeded the threshold Gmax or Gmin or not, for example.

In Step a2, it is determined whether electric power is being supplied from the vehicle power source 50 or not. When the power supply is found to be present, the procedure proceeds to Step a3. When the power supply is found to be absent, the procedure proceeds to Step a4. In Step a3, the above-described first recording operation is performed. Following the completion of the first recording operation, the sequence of operating steps come to an end. In Step a4, the above-described second recording operation is performed. Following the completion of the second recording operation, the sequence of operating steps come to an end.

As has heretofore been described, according to the present embodiment, in the second SD-RAM 32 is stored information concerning the vehicle in a cyclic manner. In a case where a predetermined condition was fulfilled, for example, where the G sensor output value representing the gravitational acceleration exerted in the anteroposterior direction and lateral direction of the vehicle 2 exceeded a predetermined threshold, under the control of the CPU 11, the first recording operation is performed that the information concerning the vehicle stored in the second SD-RAM 32 is recorded on the CF card 3. When the supply of electric power from the vehicle power source 50 is interrupted during the first recording operation, the backup power source section 27 acts as backup for the supply of electric power from the vehicle power source 50 to the CPU 11. In a case where electric power is supplied from the backup power source section 27 to the CPU 11 which is supplied with electric power from the vehicle power source 50, the operation is shifted from the first recording operation to the second recording operation that under the control of the CPU 11, part of the information concerning the vehicle stored in the second SD-RAM 32 is recorded on the CF card 3. The expression “part of the information” refers to the information portion corresponding to the duration of time that the supply of electric power from the backup power source section 27 to the CPU 11 is available, and more particularly refers to the amount of information that can be recorded on the CF card 3 during the time electric power is being supplied to the CPU 11 from the backup power source section 27.

Accordingly, even if the supply of electric power from the vehicle power source 50 is interrupted, the CPU 11 is able to exercise control in such a manner that part of the information concerning the vehicle stored in the second SD-RAM 32 can be recorded on the CF card 3 without fail by exploiting the electric power supply from the backup power source section 27.

Moreover, as has heretofore been described, according to the present embodiment, under circumstances where a signal indicative of a command to record the information of images taken by the camera 6 is issued and the main power source's power detection portion 52 detects the presence of electric power supply from the vehicle power source 50, the CPU 11 performs the first recording operation in a manner that the image information stored in the second SD-RAM 32 on a frame-by-frame basis within a predetermined period of time including the time at which the command was issued can be recorded on the CF card 3 successively in the order in which the frames were stored in the second SD-RAM 32.

On the other hand, under circumstances where a signal indicative of a command to record the information of images taken by the camera 6 is issued and the main power source's power detection portion 52 detects the absence of electric power supply from the vehicle power source 50, the CPU 11 performs the second recording operation which differs from the first recording operation in a manner that at least part of the image information stored in the second SD-RAM 32 on a frame-by-frame basis can be recorded on the CF card 3 by exploiting the electric power supply from the backup power source section 27. More specifically, the second recording operation is carried out by the CPU 11 in a manner that, out of the image information stored in the second SD-RAM 32 on a frame-by-frame basis, that part thereof which remains after thinning out a part of the frames from the image information stored in the second SD-RAM 32 can be recorded on the CF card 3.

By doing so, for example, even if the vehicle is involved in an accident and consequently the supply of electric power from the vehicle power source 50 is interrupted due to the impact of the accident, by exploiting the electric power supply from the backup power source section 27, it is possible for that part of the image information stored in the second SD-RAM 32 which remains after thinning out a part of the frames therefrom to be recorded on the CF card 3 without fail. Accordingly, on the basis of the image information recorded on the CF card 3, for example, the details of the state of the accident and the driving conditions of the vehicle can be closely analyzed.

Moreover, that part of the image information stored in the second SD-RAM 32 which remains after thinning out a part of the frames therefrom every a predetermined number of the frames can be recorded on the CF card 3. In this case, for example, it is possible to maintain the chronological relationship among the frames in a predetermined period of time including the time at which a signal indicative of a command to record the information of images taken by the camera 6 was issued. Accordingly, even if the image information recorded on the CF card 3 is that part of the image information stored in the second SD-RAM 32 which remains after thinning out a part of the frames therefrom every a predetermined number of the frames, for example, it is possible to allow relatively easy checking and analysis of the state of the accident and the driving conditions of the vehicle.

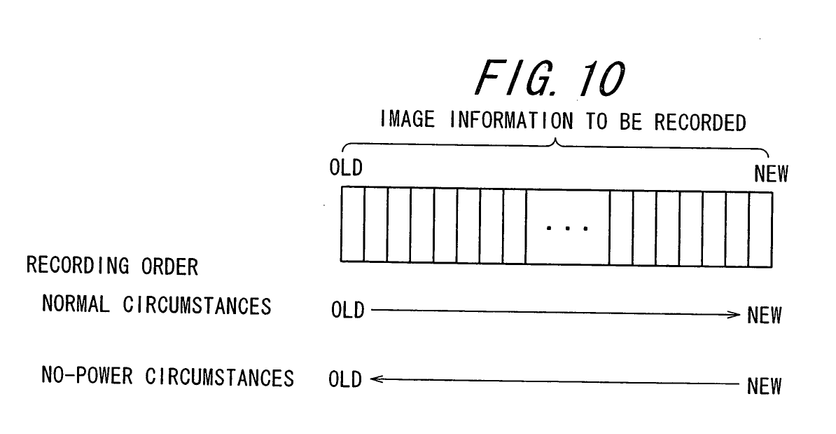

FIG. 10 is a view of assistance in explaining the execution of the second recording operation for a case where the image information stored in the second SD-RAM 32 is recorded on the CF card 3 successively in reverse chronological order. Under the normal circumstances, the CPU 11 performs the first recording operation in a manner that the image information stored in the second SD-RAM 32 within a predetermined period of time including the time at which a signal indicative of a command to record the image information stored in the second SD-RAM 32 on the CF card 3 was issued can be recorded on the CF card 3 successively in the order in which the frames were stored in the second SD-RAM 32.

Under the no-power circumstances, out of the image information stored in the second SD-RAM 32, the frames stored later will be image information of more importance than the frames stored earlier in terms of analysis of the state of the accident and the driving conditions of the vehicle.

Accordingly, the present embodiment is so designed that, under the no-power circumstances, the CPU 11 performs, instead of the second recording operation as explained with reference to FIG. 8 and Step a4 of FIG. 9 to record that part of the image information stored in the second SD-RAM 32 which remains after thinning out a part of the frames therefrom on the CF card 3, such a second recording operation as suggested hereunder.

That is, under the no-power circumstances, the CPU 11 performs the second recording operation that differs from the first recording operation in a manner that at least part of the image information stored in the second SD-RAM 32, to be specific, certain later stored frames including a frame which has been stored in the second SD-RAM 32 at the time when a signal indicative of a command to record the image information on the CF card 3 was issued upon the fulfillment of a predetermined condition and the main power source's power detection portion 52 detected the absence of electric power supply from the vehicle power source 50, can be recorded on the CF card 3 successively in reverse chronological order retrospectively from the time of the detection by exploiting the electric power supply from the backup power source section 27. Note that the aforementioned predetermined condition means, for example, that the G sensor output value representing the gravitational acceleration exerted in the anteroposterior direction and lateral direction of the vehicle 2 exceeds a predetermined threshold.

As has heretofore been described, according to the present embodiment, under the circumstances where a signal indicative of a command to record the information of images taken by the camera 6 is issued and the main power source's power detection portion 52 detects the absence of electric power supply from the vehicle power source 50, the CPU 11 performs the second recording operation which differs from the first recording operation in a manner that at least part of the image information stored in the second SD-RAM 32 on a frame-by-frame basis can be recorded on the CF card 3 by exploiting the electric power supply from the backup power source section 27.

More specifically, the CPU 11 performs the second recording operation in a manner that the later stored frames including a frame which has been stored in the second SD-RAM 32 at the time when a signal indicative of a command to record the image information on the CF card 3 was issued and the main power source's power detection portion 52 detected the absence of electric power supply from the vehicle power source 50 can be recorded on the CF card 3 successively in reverse chronological order.

By doing so, for example, even if the vehicle is involved in an accident and consequently the supply of electric power from the vehicle power source 50 is interrupted due to the impact of the accident, with use of the electric power supply from the backup power source section 27, it is possible to record without fail, on the CF card 3, out of the image information stored in the second SD-RAM 32, the later stored frames including a frame which has been stored in the second SD-RAM 32 at the time when a signal indicative of a command to record the image information on the CF card 3 was issued and the main power source's power detection portion 52 detected the absence of electric power supply from the vehicle power source 50, as well as other frames which are close timewise to the later stored frames.

Accordingly, on the basis of the image information recorded on the CF card 3, more particularly, the image information including the frames which play a key role in carrying out the analysis of the state of the accident and the driving conditions of the vehicle, for example, the details of the state of the accident and the driving conditions of the vehicle can be closely analyzed.

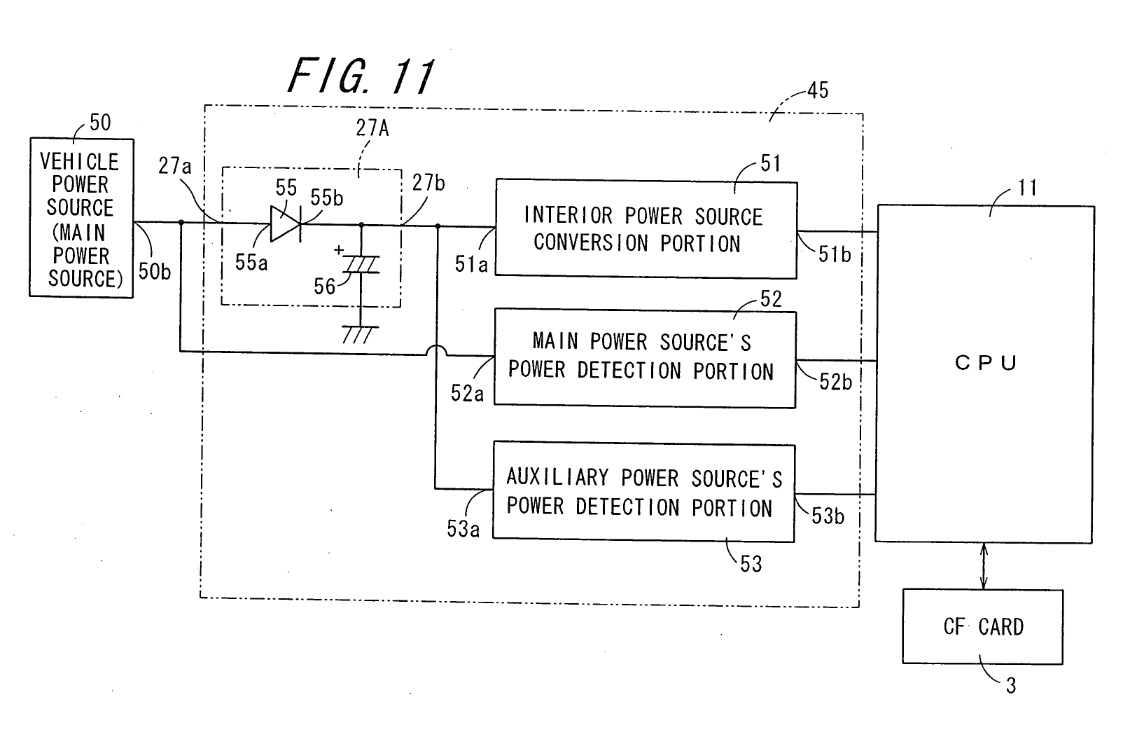

Next, a description will be given below as to the drive recorder in accordance with another embodiment of the invention. FIG. 11 is a block diagram showing a part of the configuration of the drive recorder of another embodiment of the invention. The drive recorder of this embodiment is provided with a backup power source section 45 configured differently from the backup power source section 27 of the embodiment as shown in FIG. 1. The backup power source section 45, acting as an auxiliary power source section, is composed of a backup circuitry portion 27A, an interior power source conversion portion 51, a main power source's power detection portion 52 acting as a power detecting section, and an auxiliary power source's power detection portion 53 acting as a detecting section.

The configurations and functions of the backup circuitry portion 27A, the interior power source conversion portion 51, and the main power source's power detection portion 52 of this embodiment are analogous to those of the backup circuitry portion 27A, the interior power source conversion portion 51, and the main power source's power detection portion 52 of the preceding embodiment as shown in FIG. 7. Therefore, those constituent components will be identified with the same reference symbols as in FIG. 7 and the description thereof will be omitted. Moreover, since the backup power source section 45 of this embodiment is similar in structure to the above-described backup power source section 27 as shown in FIG. 7, only the points of difference will be explained hereinbelow.

An output portion 27b of the backup circuitry portion 27A, more specifically, the point of connection between a cathode 55b of a diode 55 and a positive terminal of a capacitor 56 is electrically connected to an input portion 51a of the interior power source conversion portion 51 and also to an input portion 53a of the auxiliary power source's power detection portion 53. The auxiliary power source's power detection portion 53 has its output portion 53b electrically connected to the CPU 11.

The auxiliary power source's power detection portion 53 detects the voltage value or current value outputted from the backup circuitry portion 27A and then provides the result of the detection to the CPU 11. On the basis of the voltage value or current value provided from the auxiliary power source's power detection portion 53, the CPU 11 makes a judgment as to whether the image information stored in the second SD-RAM 32 can be recorded on the CF card 3 or not. When it is judged that the recording is possible, the CPU 11 performs the second recording operation in a manner that, as has already been described with reference to FIG. 8, certain image information is recorded on the CF card 3 after the thinning-out of the information, or in a manner that, as has already been described with reference to FIG. 10, certain image information is recorded on the CF card 3 successively in reverse chronological order.

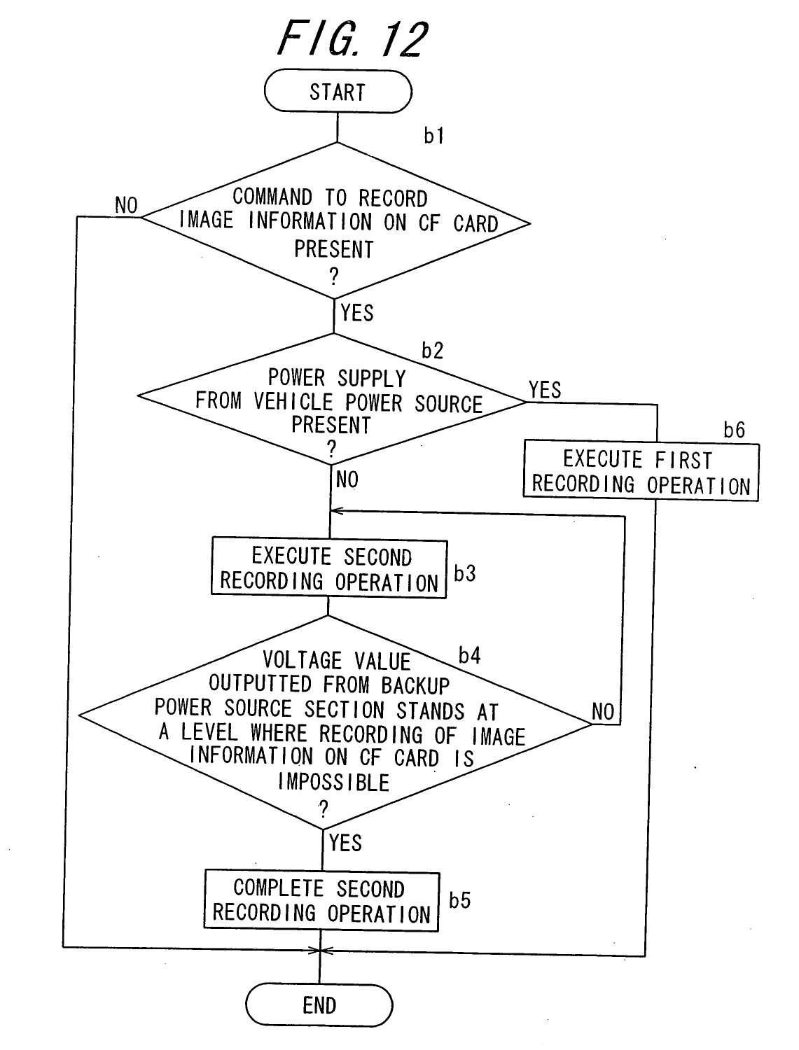

FIG. 12 is a flow chart showing the procedural steps to be followed by the CPU 11 in regard to the operation to complete the recording of image information on the CF card 3. In the flow chart shown in FIG. 12, the operation starts a sequence of steps at the condition of turning the drive recorder main body 5 on. The operation is executed by the CPU 11. Upon start-up of the operation, the procedure proceeds to Step b1.

The process in Step b1 is the same as that in Step a1 shown in FIG. 9, and also the process in Step b2 is the same as that in Step a2 shown in FIG. 9. Therefore, the detailed description of Steps b1 and b2 will be omitted. When it is determined in Step b2 that electric power is being supplied from the vehicle power source 50, the procedure proceeds to Step b6. The process in Step b6 is the same as that in Step a3 shown in FIG. 9. Therefore, the detailed description of Steps b6 will be omitted.

In Step b3, by way of the second recording operation, as has already been described with reference to FIG. 8, certain image information stored in the second SD-RAM 32 is recorded on the CF card 3 after the thinning-out of the information, or, as has already been described with reference to FIG. 10, certain image information stored in the second SD-RAM 32 is recorded on the CF card 3 successively in reverse chronological order. Following the completion of the second recording operation, the procedure proceeds to Step b4.

In Step b4, it is determined whether or not the output voltage value or output current value fed from the backup power source section 27, which has been provided from the auxiliary power source's power detection portion 53, stands at a level where the recording of the image information stored in the second SD-RAM 32 on the CF card 3 is impossible. When the recording of the image information on the CF card 3 is found to be impossible, the procedure proceeds to Step b5. When the recording of the image information on the CF card 3 is found to be possible, the procedure returns to Step b3 to continue the execution of the second recording operation described above.

In Step b5, the second recording operation in Step b3 is brought to an end. Following the completion of Step b5, the sequence of operating steps come to an end.

According to the preceding embodiment, with use of the electric power supply from the backup power source section 27, the second recording operation is performed to effect the recording of the image information stored in the second SD-RAM 32 on the CF card 3. However, if the supply of electric power from the backup power source section 27 is interrupted during the time the second recording operation is being carried out, there may arise a problem in that the image information recorded at the time of the interruption of the power supply cannot be read off the CF card 3, or that the corruption of the recorded image information takes place.

In view of the foregoing, according to the present embodiment, it is determined whether the supply of electric power from the backup power source section 27 is interrupted or not during the time the second recording operation is being carried out. More specifically, as seen from Step b4 of the flow chart shown in FIG. 12, the CPU 11 makes a judgment as to whether or not the output voltage value or output current value fed from the backup power source section 27, which has been provided from the auxiliary power source's power detection portion 53, stands at a level where the recording of the image information stored in the second SD-RAM 32 on the CF card 3 is impossible. When it is judged by the CPU 11 that the recording of the image information on the CF card 3 is impossible, the second recording operation is brought to an end.

By doing so, it is possible to prevent occurrence of the problem in that, due to the interruption of the power supply from the backup power source section 27 during the time the second recording operation is being carried out, the image information recorded at the time of the interruption of the power supply cannot be read off the CF card 3 or the corruption of the recorded image information takes place.

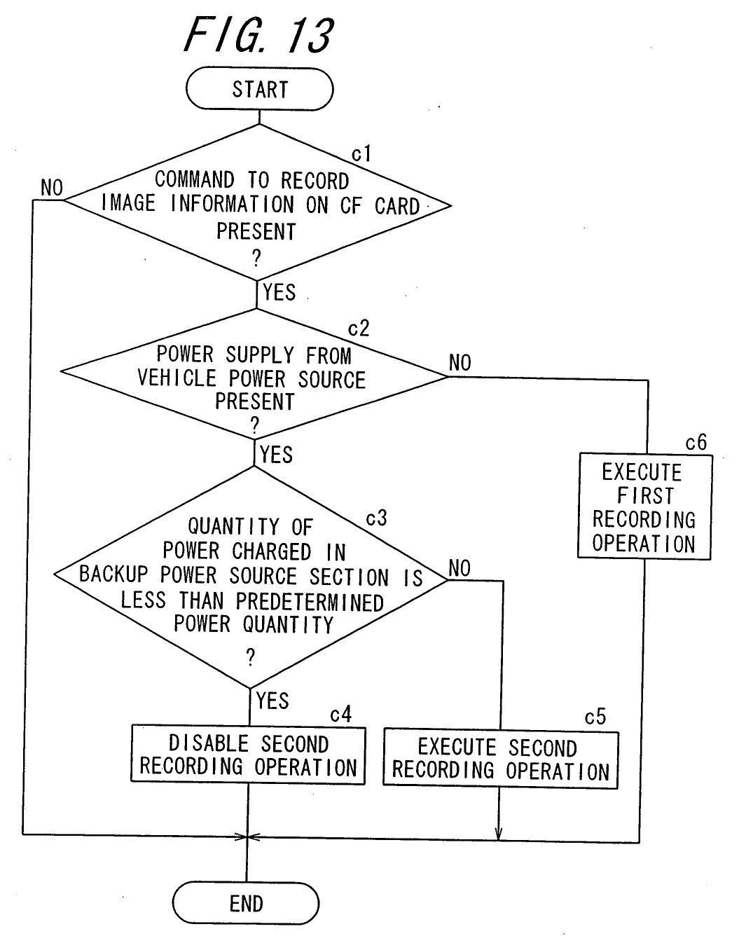

FIG. 13 is a flow chart showing the procedural steps to be followed by the CPU 11 in regard to the operation to disable the recording of image information on the CF card 3. In the flow chart shown in FIG. 13, the operation starts a sequence of steps at the condition of turning the drive recorder main body 5 on. The operation is executed by the CPU 11. Upon start-up of the operation, the procedure proceeds to Step c1.

The process in Step c1 is the same as that in Step a1 shown in FIG. 9, and also the process in Step c2 is the same as that in Step a2 shown in FIG. 9. Therefore, the detailed description of Steps c1 and c2 will be omitted. When it is determined in Step c2 that electric power is being supplied from the vehicle power source 50, the procedure proceeds to Step a3. The process in Step c6 is the same as that in Step a3 shown in FIG. 9. Therefore, the detailed description of Steps c6 will be omitted.

In Step c3, when the quantity of electric power charged in the backup power source section 27 (hereinafter also referred to as the “charged power quantity”) is found to be less than a predetermined power quantity, the procedure proceeds to Step c4. When the charged power quantity is found to be greater than or equal to the predetermined power quantity, the procedure proceeds to Step c5. In the present embodiment, the predetermined power quantity refers to the quantity of electric power required to record, out of the image information stored in the second SD-RAM 32, 1 frame of still image on the CF card 3.

In Step c4, there is effected the disabling of the second recording operation to record certain image information stored in the second SD-RAM 32 on the CF card 3 after the thinning-out of the information, as has already been described with reference to FIG. 8, or the second recording operation to record certain image information stored in the second SD-RAM 32 on the CF card 3 successively in reverse chronological order, as has already been described with reference to FIG. 10. Following the completion of Step c4, the sequence of operating steps come to an end.

In Step c5, the second recording operation such as mentioned hereinabove is carried out. Following the completion of Step c5, the sequence of operating steps come to an end.

According to the preceding embodiment, with use of the electric power supply from the backup power source section 27, the second recording operation is performed to effect the recording of the image information stored in the second SD-RAM 32 on the CF card 3. However, if the second recording operation is effected in a case where the quantity of electric power charged in the backup power source section 27 is less than the predetermined power quantity, there will arise a problem in that the image information stored in the second SD-RAM 32 cannot be recorded on the CF card 3, or, although the recording itself has been finished somehow, the recorded image information could be corrupt.

In view of the foregoing, according to the present embodiment, as seen from Step c3 of the flow chart shown in FIG. 13, prior to the execution of the second recording operation to record the image information stored in the second SD-RAM 32 on the CF card 3 by exploiting the electric power supply from the backup power source section 27, the CPU 11 makes a judgment as to whether or not the quantity of electric power charged in the backup power source section 27 is less than the predetermined power quantity. When it is judged by the CPU 11 that the quantity of electric power charged in the backup power source section 27 is less than the predetermined power quantity, the second recording operation is disabled.

By doing so, it is possible to prevent occurrence of the problem in that, due to the execution of the second recording operation in spite of the fact that the quantity of electric power charged in the backup power source section 27 is less than the predetermined power quantity, the image information stored in the second SD-RAM 32 cannot be recorded on the CF card 3, or, although the recording itself has been finished somehow, the recorded image information could be corrupt.

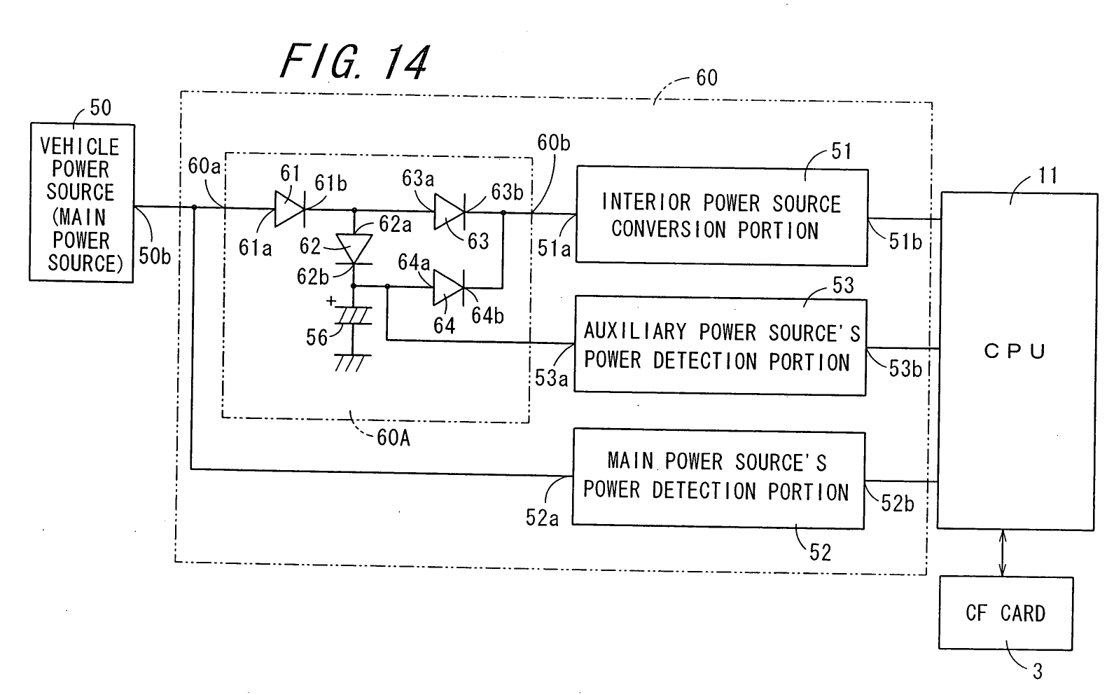

Next, a description will be given below as to the drive recorder 1 in accordance with still another embodiment of the invention. FIG. 14 is a block diagram showing a part of the configuration of the drive recorder of still another embodiment of the invention. The drive recorder of this embodiment is provided with a backup power source section 60 configured differently from the backup power source section 27 of the embodiment shown in FIG. 1. The backup power source section 60, acting as an auxiliary power source section, is composed of a backup circuitry portion 60A, an interior power source conversion portion 51, a main power source's power detection portion 52 acting as a power detecting section, and an auxiliary power source's power detection portion 53 acting as a detecting section.

The configurations and functions of the interior power source conversion portion 51, the main power source's power detection portion 52, and the auxiliary power source's power detection portion 53 of this embodiment are analogous to those of the interior power source conversion portion 51, the main power source's power detection portion 52, and the auxiliary power source's power detection portion 53 of the preceding embodiment as shown in FIG. 11. Therefore, those constituent components will be identified with the same reference symbols as in FIG. 11 and the description thereof will be omitted. Moreover, the backup power source section 60 of this embodiment has basically the same structure as the above-described backup power source section 45 as shown in FIG. 11, the only difference being the configuration of the backup circuitry portion 60A. Therefore, only the configuration of the backup circuitry portion 60A will be explained hereinbelow.

The backup circuitry portion 60A of the present embodiment is composed of a first diode 61, a second diode 62, a third diode 63, a fourth diode 64, and a capacitor 56. More specifically, the vehicle power source 50 has its output portion 50b electrically connected to an anode 61a of the first diode 61. A cathode 61b of the first diode 61 is electrically connected to an anode 62a of the second diode 62 and also to an anode 63a of the third diode 63.

The second diode 62 has its cathode 62b connected to a positive terminal of the capacitor 56, the other end of which is connected to ground. The point of connection between the cathode 62b of the second diode 62 and the positive terminal of the capacitor 56 is electrically connected to an anode 64a of the fourth diode 64 and also to an input portion 53a of the auxiliary power source's power detection portion 53. A cathode 63b of the third diode 63 and a cathode 64b of the fourth diode 64 are each electrically connected to the interior power source conversion portion 51.

Also in the above-described embodiment having the backup power source section 60 as shown in FIG. 14, just as is the case with the preceding embodiment shown in FIG. 11, the operations in conformity with the flow charts shown in FIGS. 12 and 13 can be carried out. Accordingly, it is possible to achieve the same effects as achieved in the preceding embodiment shown in FIG. 11.

Note that the embodiments thus far described are considered as illustrative only of the invention, and therefore modifications and changes may be made in the constructions of the embodiments within the scope of the invention. Although the above description deals with the embodiments of the drive recorder designed to perform, as the second recording operation, the recording of that part of the image information stored in the second SD-RAM 32 which remains after thinning out a part of the frames therefrom on the CF card 3, the invention is not limited to such a construction.

In regard to another embodiment of the invention, the drive recorder may be so designed as to effect, as the second recording operation, such a recording operation as suggested hereunder. That is, out of that part of the image information stored in the second SD-RAM 32 which remains after thinning out a part of the frames therefrom, certain later stored frames stored in the second SD-RAM 32 at the time when a signal indicative of a command to record the image information on the CF card 3 was issued and the main power source's power detection portion 52 detected the absence of electric power supply from the vehicle power source 50 are recorded on the CF card 3 successively in reverse chronological order. Also in this construction, the same effects as achieved in the foregoing embodiment as illustrated in FIGS. 8 and 10 can be achieved.

In the foregoing embodiment shown in FIG. 7, the backup power source section 27 is composed of the backup circuitry portion 27A, the interior power source conversion portion 51, and the main power source's power detection portion 52. Expressed differently, the backup power source section 27 is composed of a combination of the backup circuitry portion 27A, the interior power source conversion portion 51, and the main power source's power detection portion 52 in a single-piece construction. However, the invention is not limited thereto and therefore, by way of another embodiment of the invention, the backup circuitry portion 27A, the interior power source conversion portion 51, and the main power source's power detection portion 52 may be disposed independently of one another.

Moreover, in the preceding embodiment shown in FIG. 11, the backup power source section 45 is composed of the backup circuitry portion 27A, the interior power source conversion portion 51, the main power source's power detection portion 52, and the auxiliary power source's power detection portion 53. Expressed differently, the backup power source section. 45 is composed of a combination of the backup circuitry portion 27A, the interior power source conversion portion 51, the main power source's power detection portion 52, and the auxiliary power source's power detection portion 53 in a single-piece construction. However, the invention is not limited thereto and therefore, by way of another embodiment of the invention, the backup circuitry portion 27A, the interior power source conversion portion 51, the main power source's power detection portion 52, and the auxiliary power source's power detection portion 53 may be disposed independently of one another.

Further, in the above-stated embodiment shown in FIG. 14, the backup power source section 60 is composed of the backup circuitry portion 60A, the interior power source conversion portion 51, the main power source's power detection portion 52, and the auxiliary power source's power detection portion 53. Expressed differently, the backup power source section 60 is composed of a combination of the backup circuitry portion 60A, the interior power source conversion portion 51, the main power source's power detection portion 52, and the auxiliary power source's power detection portion 53 in a single-piece construction. However, the invention is not limited thereto and therefore, by way of another embodiment of the invention, the backup circuitry portion 60A, the interior power source conversion portion 51, the main power source's power detection portion 52, and the auxiliary power source's power detection portion 53 may be disposed independently of one another.

In the foregoing embodiment as illustrated in FIG. 10, under the circumstances where a signal indicative of a command to record the information of images taken by the camera 6 is issued and the main power source's power detection portion 52 detects the absence of electric power supply from the vehicle power source 50, with use of the electric power supply from the backup power source section 27, at least part of the image information stored in the second SD-RAM 32 on a frame-by-frame basis, to be specific, the later stored frames including a frame which has been stored in the second SD-RAM 32 at the time when the interruption of the power supply was detected, is recorded on the CF card 3 successively in reverse chronological order retrospectively from the time of the detection. However, the invention is not limited to such a construction.

By way of another embodiment of the invention, the drive recorder may be so designed that, under circumstances where a signal indicative of a command to record audio information inputted through the mike 7 is issued and the main power source's power detection portion 52 detects the absence of electric power supply from the vehicle power source 50, with use of the electric power supply from the backup power source section 27, at least part of the audio information stored in the second SD-RAM 32, to be specific, the later stored audio information including a piece of audio information which has been stored in the second SD-RAM 32 at the time when the interruption of the power supply was detected, is recorded on the CF card 3 successively in reverse chronological order retrospectively from the time of the detection.

In another embodiment of the invention, the time point of occurrence of trigger may be adopted as the reference, instead of the time point of start of no-power circumstances, in the second recording operation for recording the image information on the CF card 3 under the no-power circumstances. That is to say, when the no-power circumstances, i.e., the absence of electric power supply from the vehicle power source 50 is detected in recording the still image information stored in the second SD-RAM 32 on the CF card 3 after the detection of trigger, the still image information stored in the second SD-RAM 32 is recorded on the CF card 3, by using the time point of occurrence of trigger as the reference, successively in the order of from the still image information stored in the second SD-RAM 32 at the time point of occurrence of trigger to the still image information stored the predetermined time before the time point of occurrence of trigger, or in the reverse order of from the still image information stored the predetermined time before the time point of occurrence of trigger to the still image information stored at the time point of occurrence of trigger.

The above predetermined time which defines the recording range, may be set to twelve seconds the same as in the case of the first recording operation, and in order to reduce the backup power source section in size, the above predetermined time may also be set shorter than twelve seconds (e.g. ten seconds). Further, in a case of recording the still image information stored in the second SD-RAM 32 according to the above-mentioned recording procedure, the thinning-out operation shown in FIG. 8 may be performed.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A vehicle information recording apparatus comprising:
a first memory for recording information concerning a vehicle in a cyclic manner; and
a recording control section for recording the information in a predetermined range recorded on the first memory on a second memory in accordance with a predetermined condition,
wherein the recording control section is supplied with electric power from a main power source section,
wherein the vehicle information recording apparatus comprises an auxiliary power source section acting as a backup for electric power supply from the main power source section to the recording control section,
and wherein the recording control section allows, in a case where electric power is supplied from the auxiliary power source section, part of the information in the predetermined range recorded on the first memory to be recorded on the second memory.

2. The vehicle information recording apparatus according to claim 1,
wherein the information is information of images taken by an image taking apparatus mounted in the vehicle.

3. The vehicle information recording apparatus according to claim 1,
wherein part of the information is vehicle information stored from a predetermined time before the time point of occurrence of trigger to the time point of detection of voltage drop to the time point of occurrence of trigger, the information corresponding to a duration of time that the supply of electric power from the auxiliary power source section to the recording control section is available.

4. The vehicle information recording apparatus according to claim 1,
wherein the recording control section records part of the information on the second memory retrospectively from a time when the predetermined condition was fulfilled.

5. The vehicle information recording apparatus according to claim 1,
wherein the predetermined condition is a state in which a signal issued from an impact detecting section for detecting an impact exerted on the vehicle exceeds a predetermined threshold.

6. A vehicle information recording apparatus comprising:
an inputting section for inputting image information provided from an image taking apparatus mounted in a vehicle;
a first memory;
a memory connecting section to which a second memory is attached detachably;
a power detecting section for detecting a presence or absence of electric power supply from a main power source section mounted in the vehicle;
a control section for effecting control in such a manner that the image information provided from the inputting section is temporarily stored in the first memory on a frame-by-frame basis in chronological order, and, upon a signal indicative of recording of the image information being issued, the image information stored in the first memory is recorded on the second memory attached to the memory connecting section; and
an auxiliary power source section for supplying, when an interruption of power supply from the main power source section mounted in the vehicle is detected by the power detecting section, electric power to the first memory, the memory connecting section, and the control section,
wherein the control section performs, under circumstances where a signal indicative of recording of the image information is issued and the power detecting section detects the presence of electric power supply from the main power source section, a first recording operation to record the image information stored in the first memory on the second memory successively in the order in which the frames were stored in the first memory,
and wherein the control section performs, under circumstances where a signal indicative of recording of the image information is issued and the power detecting section detects the absence of electric power supply from the main power source section, a second recording operation, which differs from the first recording operation, to record at least part of the image information stored in the first memory on the second memory by exploiting electric power supply from the auxiliary power source section.

7. The vehicle information recording apparatus according to claim 6,
wherein at least part of the image information is part of the image information stored in the first memory which remains after thinning out a part of the frames from the image information.

8. The vehicle information recording apparatus according to claim 6,
wherein at least part of the image information is part of the image information stored in the first memory and includes a frame that has been stored in the first memory at the time when a signal indicative of recording of the image information was issued and the power detecting section detected the absence of electric power supply from the main power source section.

9. The vehicle information recording apparatus according to claim 7,
wherein at least part of the image information is part of the image information stored in the first memory and includes a frame that has been stored in the first memory at the time when a signal indicative of recording of the image information was issued and the power detecting section detected the absence of electric power supply from the main power source section.

10. The vehicle information recording apparatus according to claim 8,
wherein the control section performs the second recording operation in a manner that at the time when a signal indicative of recording of the image information was issued and the power detecting section detected the absence of electric power supply from the main power source section, frames stored in the first memory are recorded on the second memory successively from a latest frame in reverse chronological order.

11. The vehicle information recording apparatus according to claim 9,
wherein the control section performs the second recording operation in a manner that at the time when a signal indicative of recording of the image information was issued and the power detecting section detected the absence of electric power supply from the main power source section, frames stored in the first memory are recorded on the second memory successively from a latest frame in reverse chronological order.

12. The vehicle information recording apparatus according to claim 6, further comprising:
a detecting section for detecting an output voltage or output current produced from the auxiliary power source section,
wherein, in accordance with a result of detection provided from the detecting section, the control section brings the second recording operation to an end before the image information is no longer recorded on the second memory by exploiting electric power supply from the auxiliary power source section.

13. The vehicle information recording apparatus according to claim 6,
wherein the auxiliary power source section is formed of a rechargeable battery which becomes charged by electric power fed from the main power source section,
wherein the vehicle information recording apparatus further comprises a detecting section for detecting an output voltage or output current produced from the auxiliary power source section,
and wherein, in accordance with a result of detection provided from the detecting section, the control section disables execution of the second recording operation when the recording of the image information on the second memory is found to be impossible.
